(19) United States
(12) Patent Application Publication
(10) Pub. No.: US 2024/0035295 A1
(43) Pub. Date: Feb. 1, 2024

(54) Method of Making a Popcorn Patch Article

(71) Applicant: Jennifer Judd, East Hampton, CT (US)

(72) Inventor: Jennifer Judd, East Hampton, CT (US)

(21) Appl. No.: 17/874,386

(22) Filed: Jul. 27, 2022

(51) Int. Cl. E04G 23/02; B05D 5/02

(52) U.S. Cl. CPC E04G 23/02; B05D 5/02

(57) ABSTRACT

A method for making a popcorn patch article, comprising creating an acoustic mixture by mixing a liquid and a popcorn texture, or mixing a popcorn texture and water to create an acoustic mixture, or mixing a popcorn texture and paint to create an acoustic mixture, or mixing a popcorn texture and a primer to create an acoustic mixture, or mixing a popcorn texture by any means available to create an acoustic mixture. Then, applying the acoustic mixture to a facing surface of a flexible substrate having a sticky surface opposite the facing surface, or pouring into a mould.

### CROSS-REFERENCE TO ANY RELATED APPLICATION(S)

None.

### BACKGROUND OF THE INVENTION

### Field of the Invention

The present invention relates generally to housing repairs. More particularly, the present invention relates to a method of making a popcorn patch article to repair ceilings or walls.

### Description of the Prior Art

Many homes are built with ceilings made either of gypsum board, covered with a thin layer of “mud” (plaster) or entirely of plaster over lath. Often, gypsum board ceilings have been finished with an acoustic texture material commonly known as “popcorn.” This type of ceiling was particularly popular during the 1980s and has continued to be used in new construction.

Although any sort of ceiling can suffer damage from a variety of causes (bumps and scratches by moving objects, water leaks, and so forth), popcorn ceilings can be particularly challenging to repair. Even if the damaged structure (gypsum board and plaster) can merely be patched instead of being completely replaced, the acoustic texture material must be repaired in a way that matches the surrounding surface. Professionals in the field agree that achieving a visual match of popcorn texture is a time consuming and highly frustrating endeavor.

Current methods of fixing a popcorn ceiling include: removal of all popcorn on entire ceiling surfaces where the damage is (messy, costly, time consuming); spraying popcorn texture from a can onto the damaged area (e.g., disclosed by U.S. Pub. 2013/0112340); rolling or brushing paint and popcorn texture onto the damaged area; or spraying paint and popcorn texture from a popcorn sprayer apparatus onto the damaged area.

Spraying of popcorn requires blocking off the spray area with sheets of plastic by dropping the plastic from the ceiling to the floor (held by tape or tacks), as well as on the floor underneath. Over spray is significant and will adhere to the surrounding areas if not properly blocked. Despite best efforts of skilled workers, sprayed texture seldom exactly matches the existing surrounding popcorn texture, so that homeowners are seldom pleased with the results. Similarly, brushed or rolled texture also very seldom matches the extant surfaces to the point of satisfaction.

A more exotic technique for matching popcorn texture is to mold and cast an exact copy of adjacent popcorn texture (e.g., as disclosed by U.S. Pat. No. 8,349,110).

A better method for repairing popcorn texture is making a popcorn patch article (e.g., as disclosed by U.S. Pat. No. 9,624,644) and applying it to the damaged surface (e.g., as disclosed by U.S. Pat. No. 9,896,853). However, the previously disclosed method of making a popcorn patch article can be improved upon with the novel method disclosed here by making it easier to scale the making of popcorn patch articles and by doing so more quickly and efficiently.

### Statement of the Objects of the Invention

An object of the present invention is to provide a method for making a popcorn patch article. A further object of the present invention is to provide a method for making a popcorn patch article for textured ceiling, wall, and other building repairs. More particularly, an object of the present invention is to provide a method for making a popcorn patch article that is quicker and more efficient than previous methods. Additional objects and advantages of the present invention will be apparent to those skilled in the art from the description of the invention, taken in conjunction with the attached drawings.

### BRIEF SUMMARY OF THE INVENTION

A method for making a popcorn patch article, comprising creating an acoustic mixture by mixing at least a liquid and a popcorn texture, or mixing a popcorn texture and water to create an acoustic mixture, or mixing a popcorn texture and paint to create an acoustic mixture, or mixing a popcorn texture and a primer to create an acoustic mixture, or mixing a popcorn texture by any means available to create an acoustic mixture. Then, applying the acoustic mixture to a facing surface of a flexible substrate having a sticky surface opposite the facing surface.

### BRIEF DESCRIPTION OF THE DRAWINGS

The present invention will now be discussed in further detail below with reference to the accompanying figures in which:

FIG. 1 illustrates a popcorn patch article;

FIG. 2-3 illustrates one method of making an acoustic mixture and applying the acoustic mixture to a facing surface of a flexible substrate to make a popcorn patch article according to the present invention. The acoustic mixture may also be applied to the facing surface of the flexible substrate by spraying, brushing, rolling or poured into a mould to make a popcorn pat article according to the present invention.

### DETAILED DESCRIPTION OF THE ILLUSTRATED EMBODIMENT

While the present invention is susceptible of embodiments in various forms, there is shown in the drawings and will hereinafter be described certain exemplary and non-limiting embodiments, with the understanding that the present disclosure is to be considered an exemplification for the invention and is not intended to limit the invention to the specific embodiments illustrated. In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects.

A popcorn or acoustic ceiling patch (“Popcorn Patch”), according to an embodiment of the present invention, is a patch that has a simulated popcorn texture with peel and stick backing. It is a flexible and paintable texture that is easily applied to the damaged area of the ceiling. It is available in at least three different popcorn textures ranging from small popcorn texture to large. It is available in various sizes from small to large, for example but no limited too: a) 4″×4″ Patch b) 6″×6″ Patch c) 6″×6′ Roll. The large roll can be cut to size and used for many sized areas such as narrow, long strips along the ceiling where the wall and ceiling meet, or larger damaged ceiling areas than what the smaller Popcorn Patch would be used for. The large roll can be used in its entirety, similar to wallpaper, in order to cover large ceiling areas. Indeed, the large roll might be used for original installation of popcorn ceiling in new construction.

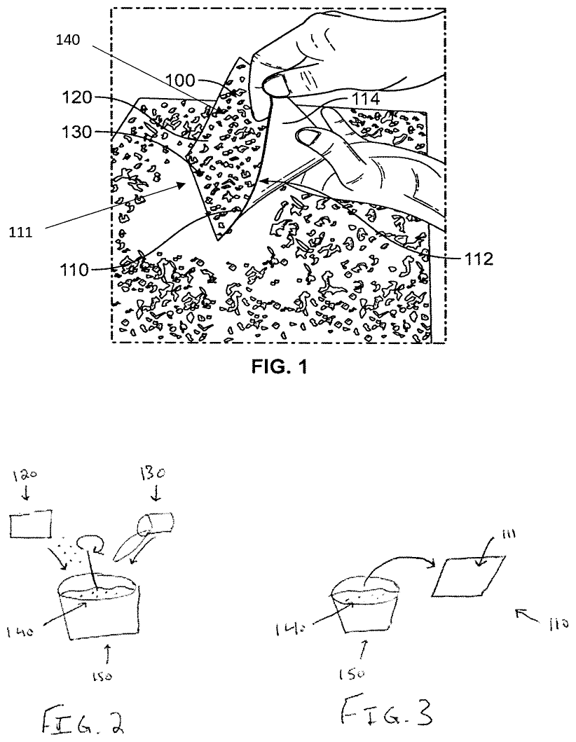

Referring now to FIG. 1, in one embodiment of the present invention, a popcorn patch article 100 comprises a flexible substrate 110 with a facing surface 111 and a sticky surface 112 having a removable backing layer 114, e.g., “Controltac Graphic Marketing System” brand label material as manufactured by 3M, or any sticky-backed cellulose, cloth, polymer, or metal substrate having structural properties suitable for use in the forms above described. Although the “Controltac” brand label material has an adhesive applied as its sticky surface, sticky surfaces equally may be mechanically formed—e.g., as microfibers, similar to the hairs of a gecko's foot; or as hooked fibers, similar to those hook-and-loop fasteners, or as spines or prickles, with or without barbs, e.g., similar to those of thistle or cacti. Although the exemplary “Controltac Graphic Marketing System” has a non-sticky facing surface and is convenient to handle, it may be equally acceptable to use a substrate that has two sticky surfaces, e.g., in the nature of double-sided tape. The popcorn patch article 100 further comprises an acoustic mixture 140 of a popcorn texture 120 (e.g., Homax brand, Zinnser brand, or any other popcorn texture available in stores or equivalent substance) and a liquid 130 applied to the facing surface 111. For example, the liquid 130 can be water, paint, silicone, an adhesive liquid, or elastomeric coating (e.g., Sherwin Williams SuperDeck, or any other elastomeric type coating or flexible coating available in stores of equivalent substance).

Referring now to FIG. 2-3, the popcorn texture 120 is proportionally mixed with the liquid 130 to create the acoustic mixture 140 in a receptacle 150. The mixture 140 is then applied to a facing surface 111 of the flexible substrate 110 to create the popcorn patch article 100. For example, the mixture 140 can be applied to the facing surface 111 by spraying, brushing, rolling or pouring into a mould. In the case where the facing surface 111 of flexible substrate 110 is also a sticky surface, it is particularly desirable to ensure that the acoustic mixture 140 completely covers the facing surface 111 to minimize the accumulation of dust on the facing surface 111 during repairs. In the case where the acoustic ceiling has been water-damaged, better results may be obtained by priming the damaged ceiling prior to installation of the popcorn patch article 100, but priming is not always necessary.

In one cycle of operation of the illustrated embodiment, the popcorn texture 120 and the liquid 130 are proportionally mixed in the receptacle 150 to create the acoustic mixture 140. The acoustic mixture 140 is then applied to the facing surface 111 of the flexible substrate 110 to create the popcorn patch article 110. The popcorn patch article 110 may then be used to complete textured ceiling, wall, and other building repairs as needed by removing the removable backing layer 114 from the sticky surface 112 and applying the sticky surface 112 to the damaged ceiling area.

Specific embodiments of the novel method for construction of a popcorn patch for repairing ceilings according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

1. A method for making a popcorn patch article, comprising:
creating an acoustic mixture by mixing a liquid and a popcorn texture, wherein the liquid is selected from the group comprising an elastomeric coating, a paint, a silicone liquid, and an adhesive liquid; and
applying the acoustic mixture to a facing surface of a flexible substrate, the flexible substrate having a sticky surface opposite the facing surface.

2-6. (canceled)

7. The method of claim 1, wherein the step of applying comprises spraying.

8. The method of claim 1, wherein the step of applying comprises brushing.

9. The method of claim 1, wherein the step of applying comprises rolling.

10. The method of claim 1, further including applying the acoustic mixture to an entirety of the first surface.
